(19) United States
(12) Patent Application Publication
(10) Pub. No.: US 2003/0142140 A1
(43) Pub. Date: Jul. 31, 2003

(54) Adjusting the tint of a translucent window to convey status

(75) Inventors: Michael Wayne Brown, Georgetown, TX (US); Andrew Douglas Hately, Austin, TX (US); Kelvin Roderick Lawrence, Round Rock, TX (US); Michael A. Paolini, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY (US)

(21) Appl. No.: 10/059,027

(22) Filed: Jan. 28, 2002

(51) Int. Cl. G09G 5/00

(52) U.S. Cl. 345/803; 345/768; 345/772

(57) ABSTRACT

A method, system, and program for adding various tints to a translucent displayable object to convey a status of a computing task are provided. A tint level is specified to represent a status of a non-interactive computing task. Then, the tint of at least a selected portion of a displayable object associated with the non-interactive computing task is graphically adjusted according to the tint level, such that the status of the non-interactive computing task is displayed by the associated displayable object.

### CROSS-REFERENCE TO RELATED APPLICATIONS

The present application is related to the following co-pending applications, which are filed on even date herewith and incorporated herein by reference:

(1) U.S. patent application Ser. No. ______ (Attorney Docket No. AUS920010513US1);

(2) U.S. patent application Ser. No. ______ (Attorney Docket No. AUS920010514US1);

(3) U.S. patent application Ser. No. ______ (Attorney Docket No. AUS920010515US1);

(4) U.S. patent application Ser. No. ______ (Attorney Docket No. AUS920010516US1);

(5) U.S. patent application Ser. No. ______ (Attorney Docket No. AUS920010518US1);

(6) U.S. patent application Ser. No. ______ (Attorney Docket No. AUS920010519US1);

(7) U.S. patent application Ser. No. ______ (Attorney Docket No. AUS920010520US1);

(8) U.S. patent application Ser. No. ______ (Attorney Docket No. AUS920010521US1);

(9) U.S. patent application Ser. No. ______ (Attorney Docket No. AUS920010522US1);

(10) U.S. patent application Ser. No. ______ (Attorney Docket No. AUS920010524US1); and

(11) U.S. Patent Application Ser. No. ______ (Attorney Docket No. AUS920010525US1).

### BACKGROUND OF THE INVENTION

1. Technical Field

The present invention relates in general to computer systems and, in particular, to graphical user interfaces. Still more particularly, the present invention relates to adding a tint to a translucent window to convey a status of the application or system associated with the window.

2. Description of the Related Art

Most computer systems include multiple types of software for controlling the functions of the computer system. A first type of software is system software (operating systems), which controls the workings of the computer. A second main type of software is applications, such as word processing programs, spreadsheets, databases, and browsers, which perform the tasks for which people use computers. In addition, a computer system may include network software, which enables groups of computers to communicate, and language software, which provides programmers with the tools they need to write programs.

In particular, software contains many instructions typically executed by a processor and other hardware within a computer system. As instructions are executed, the status or progress of multiple parts of the computer system is often monitored. In particular, the status is the condition, at a particular time, of any of numerous elements of computing including, but not limited to, a device, a communications channel, a network station, a software program, a bit, or another element. A status may be utilized to report on or to control computing tasks.

Most operating systems provide a graphical user interface (GUI) for controlling a visual computer environment. The GUI represents programs, files, and options with graphical images, such as icons, menus, and dialog boxes on the screen. Graphical items defined within the GUI work the same way for the user in most software because the GUI provides standard software routines to handle these elements and report the user's actions.

A typical graphical object defined by a GUI is a window or other defined area of a display containing distinguishable text, graphics, video, audio and other information for output. A display area may contain multiple windows associated with a single software program or multiple software programs executing concurrently.

Often when multiple graphical objects are displayed concurrently, the graphical objects will overlap. The order in which graphical objects are drawn on top of one another onscreen to simulate depth is typically known as the z-order. Typically, those objects at the top of the z-axis obscure the view of those graphical objects drawn below.

Typically, the status of a window representing an application or the system is not provided until a failure has occurred, where the failure requires the application or system be closed. More sophisticated monitoring applications may provide a window for displaying the code associated with a failing application or window. However, such a window typically overlaps current open windows, thus obscuring failing windows. Even for simple failures, such as a missing file, a pop-up window is typically required to convey such information to the user, where the additional window further limits screen space.

In a network system, for example, where multiple network connections are being monitored, multiple connections may fail in some way at the same time. As the number of possible failing applications, systems, and hardware increases, determining which element has failed and why it failed becomes increasingly more difficult.

In view of the foregoing, it would be advantageous to provide a method, system, and program for displaying application, system, and hardware failures according to each application window in a manner that does not utilize additional screen space. In addition, it would be advantageous to provide a method, system, and program where failures are easily distinguishable according to window.

### SUMMARY OF THE INVENTION

In view of the foregoing, it is therefore an object of the present invention to provide an improved computer system.

It is another object of the present invention to provide an improved graphical user interface.

It is yet another object of the present invention to provide a method, system and program for adding a tint to a translucent window to convey a status of a computing task associated with the window.

According to one aspect of the present invention, a tint level is specified to represent a status of a non-interactive computing task. Non-interactive computing tasks may include usage of a processor, memory, a sound card, a graphics card, a storage device, and network bandwidth. A status may include, for example, a failure, a recovery, or an insufficiency.

Then, the tint of at least a selected portion of a displayable object within a display area associated with the non-interactive computing task is graphically adjusted according to the tint level, such that the status of the non-interactive computing task is displayed by the associated displayable object.

In addition, a selected window portion of the display area may be adjusted in tint to highlight said displayable object. Adjusting the tint of a display area is particularly advantageous where the display area is enabled to adjust in transparency and tint.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates one embodiment of a computer system with which the method, system and program of the present invention may advantageously be utilized;

FIG. 2 depicts a graphical representation of multiple application windows where a single window is tinted in accordance with the method, system, and program of the present invention;

FIG. 3 illustrates a graphical representation of multiple application windows where multiple windows are tinted in accordance with the method, system, and program of the present invention;

FIG. 4 depicts a graphical representation of tinting a background window area in accordance with the method, system, and program of the present invention;

FIG. 5 illustrates a graphical representation of a user interface for selecting tint preferences in accordance with the method, system, and program of the present invention; and

FIG. 6 depicts a high level logic flowchart of a process and program for graphically adjusting the tints of windows to represent the status of associated computing tasks in accordance with the method, system, and program of the present invention.

### DETAILED DESCRIPTION OF THE PREFERRED EMBODIMENT

A method, system, and program for adding a tint to a translucent window to convey a status of an application, system, or hardware are provided. In addition to application windows, the tint of other translucent displayable objects may be adjusted without effecting the z-order of those displayable objects. A “displayable object” may include text, icons, video, graphics, windows, or other graphical representations displayable within a display area. Displayable objects may be hidden or visible. Further, displayable objects may be layered in a z-order. Moreover, a displayable object may utilize a portion of a display area or may extend across the entirety of a display area. A displayable object may or may not include definable boundaries.

In a typical graphical display, there is both a background and foreground. Where the tint of a displayable object is adjusted in the foreground, the displayable object will visually stand out because of the tinting. Where the display area is transparent, then the background displayable object adjusts the tint and transparency of the transparent display area. Thus, the tint of a transparent display area may be adjusted, such that displayable objects visually stand out from the background.

A z-order is the order along the z-axis in which displayable objects appear. Through a z-buffering technique, a depth is associated with each displayable object such that each object appears to be set at a particular depth in comparison with other displayable objects. There may be n-levels of layers within the z-order, where multiple displayable objects may be positioned within a particular n-level of the z-order.

The z-order may be a result of the order in which a user opens displayable objects onto the display. Alternatively, according to one advantage of the present invention, a user may designate for the z-order to be set according to a particular criteria.

Transparency is a graphical feature that is particularly advantageous to the present invention when utilizing a shading characteristic of a window to indicate the status of a computing task. As will be understood by one skilled in the art, by making a displayable object appear transparent on a computer screen, other displayable objects below the displayable objects are visible through the resource aid. Therefore, by adjusting the transparency of a window, information may be conveyed. Further, the transparency of a displayable object may be adjusted from opaque to totally transparent.

Typically, the transparency attribute is stored with color values in an alpha channel. In the present invention, adjusting the alpha levels of windows corresponds to adjusting transparency attributes stored in the alpha channels. Alpha levels are adjusted according to the status of a computing task. The designated alpha level of a window, anywhere from total transparency to total opacity, may be referred to in the present invention as the translucency.

When calculating the appearance of a given pixel, the graphic processor uses the alpha channel values to determine the pixel's color through a process termed alpha blending. Through alpha blending, the process adds a fraction of the color of the transparent object set by the alpha channel value to the color of the displayable object below. Mixing the colors together gives the appearance that the displayable object below is seen through a layer of the transparent displayable object. In addition to alpha blending, additional shading may be added to create shadows and other graphical images to cue the viewer to the position of the transparent displayable object.

In the present invention, tinting is preferably a selection of a particular hue of color to apply to a displayable object. Tint levels are advantageously the color and hue of that color selected for each pixel. Where a tint and transparency are combined, the appearance of a color tinted window through which other windows are visible is created.

In the present invention, a computing task may be interactive or non-interactive. Interactive computing tasks are those performed in direct response to a user input, such as a keystroke, cursor input, or other. Non-interactive computing tasks are those not performed in direct response to a user input. For example, memory and CPU utilization are not typically performed in direct response to a user input, but are utilized as a function of an application functioning within the computer system. In an example, where a user selects a button associated with an audio function, the interactive computing task is the actual output of the audio in response to the selection while the non-interactive computing tasks include at least usage of a sound card, memory, and CPU.

Advantageously, in the present invention, non-interactive computing tasks may include, but are not limited to, use of memory, use of CPUs, number of CPUs utilized, use of graphics cards for two-dimensional (2D) and three-dimensional (3D) graphics, use of a sound card, number of threads, use of storage devices, and net bandwidth. More particularly, the status of non-interactive computing tasks may be indicated according to failures, recoveries, missing items, and other insufficiencies that alert a user to possible problems. As will be understood by one with skill in the art, additional software, hardware, and network related non-interactive computing tasks may be utilized within the present invention.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

Hardware Overview

The present invention may be executed in a variety of systems, including a variety of computing systems and electronic devices under a number of different operating systems. In one embodiment of the present invention, the computing system is a portable computing system such as a notebook computer, a palmtop computer, a personal digital assistant, a telephone or other electronic computing system that may also incorporate communications features that provide for telephony, enhanced telephony, messaging and information services. However, the computing system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

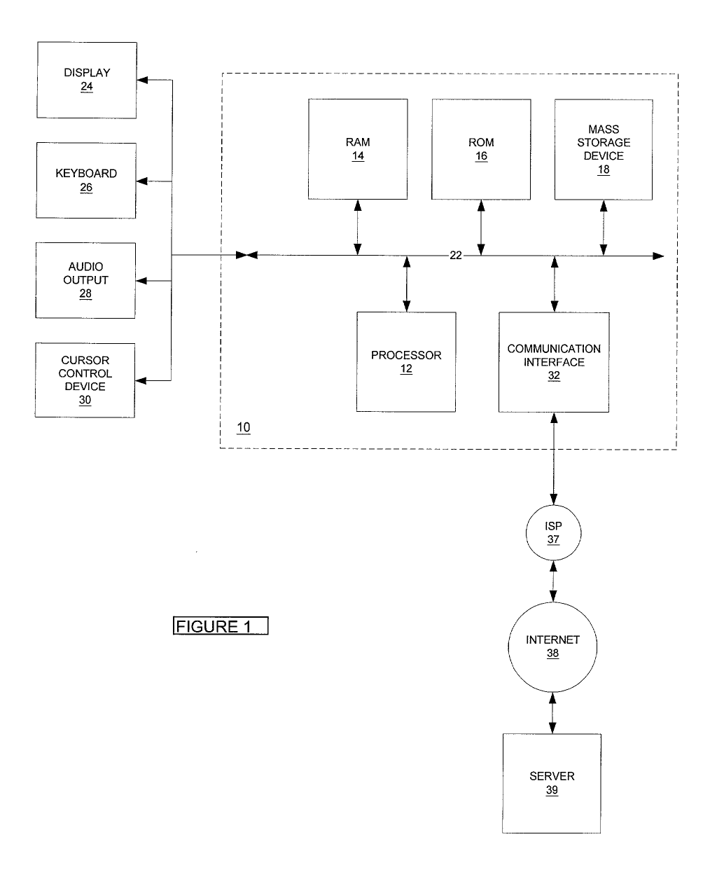

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

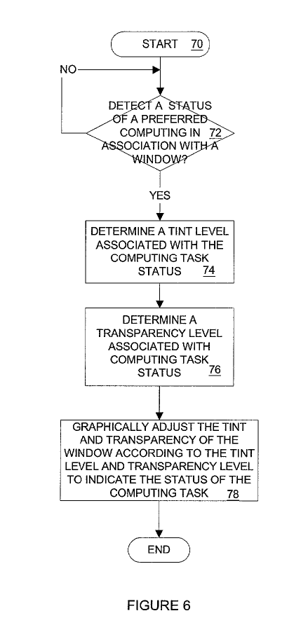

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIG. 6 and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital or analog data streams. The signals through the various networks and the signals on network link 34 and through communication interface 32, which carry the digital or analog data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. Where display 24 is output glasses or a heads up display the present invention is particularly advantageous. Further, where display 24 is large and includes multiple displayable objects the present invention is particularly advantageous.

A keyboard 26 and cursor control device 30, such as a mouse, trackball, or cursor direction keys, are coupled to bus 22 as interfaces for user inputs to computer system 10. Keyboard 26 and cursor control device 30 can control the position of a cursor positioned within a display area of display 24. Display 24 may include both non-transparent surfaces, such as monitors, and transparent surfaces, such as headset sunglasses or vehicle windshield displays.

It should be understood that keyboard 26 and cursor control device 30 are examples of multiple types of input devices that may be utilized in the present invention. In alternate embodiments of the present invention, additional input and output peripheral components may be added.

Tint Conveying Status Context

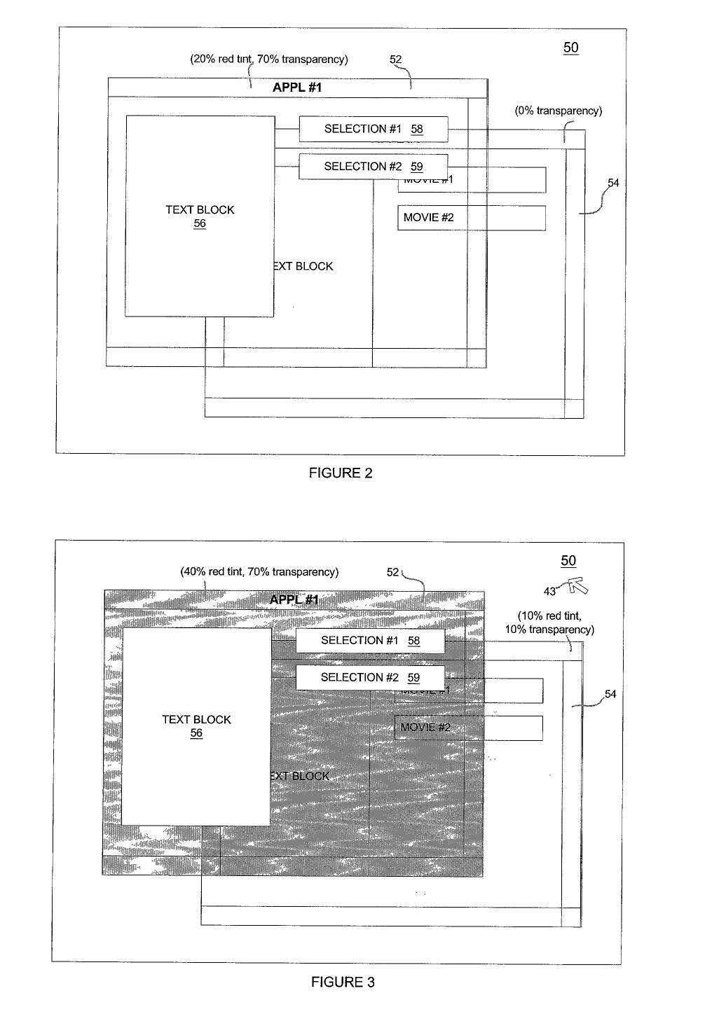

With reference now to FIG. 2, there is depicted a graphical representation of multiple application windows where a single window is tinted in accordance with the method, system, and program of the present invention. As illustrated, a user interface 50 includes windows 52 and 54.

According to one advantage of the present invention, portions of a window may adjust in transparency and tint while other portions, such as text block 56 and selectable buttons 58 and 59 do not adjust in transparency and tint. In the present example, a transparent tint is added to window 52 to indicate that failures are occurring.

In particular, as more failures occur, advantageously the hue of the tint becomes darker and darker and/or the transparency of the window may become more opaque. For example, in the present invention a red tint represents failures occurring. As the number of failures increases, the hue of the red tint advantageously increases from 20% such that the more intense a color, the greater number of failures.

According to another advantage of the present invention, window 54 is visible through window 52 such that overlapped windows are not obscured by depicting the status of a computing task. Further, advantageously, the tinting of window 52 provides the user with a visible indicator that failures are occurring in association with a window where that indicator is distinguishable for that window.

Referring now to FIG. 3, there is illustrated a graphical representation of multiple application windows where multiple windows are tinted in accordance with the method, system, and program of the present invention. As depicted, both windows 52 and 54 are tinted to represent the status of computing tasks. Here, the computing tasks represented are failures in the system by the software, hardware, or network, leading to a decrease in functionality of the software associated with windows 52 and 54.

Advantageously, windows 52 and 54 are transparent and tinted, such that even though window 52 overlaps window 54, the status of computing tasks associated with both windows 52 and 54 are visible concurrently. While in the present invention both windows 52 and 54 are tinted to represent failures associated with each window, in alternate embodiments, additional tints may be added to windows to represent the status of alternate types of computing tasks. In addition, in alternate embodiments, the status of more than one type of computing tasks may be represented within a single window where the window is partitioned into multiple tinting areas.

As an additional advantage of the present invention, the status of multiple windows may be depicted independent of which window(s) is actively selected. For example, window 52 is actively selected, however the tints of windows 52 and 54 adjust according to changes in status independent of the active selection of window 52.

Further, advantageously, where a user wants to select and interact with a window, the user may position cursor 43 over that window and right-click or provide another input requesting the tinting to be temporarily suppressed while the user is interacting with the window.

Although in the present example windows 52 and 54 are displayed within the foreground of display area 50, in alternate embodiments, the background of display area 50 may adjust in tint. In particular, where display area 50 is a transparent surface, adjusting the transparency and tint of display area 50 will adjust the tint of a particular transparent window.

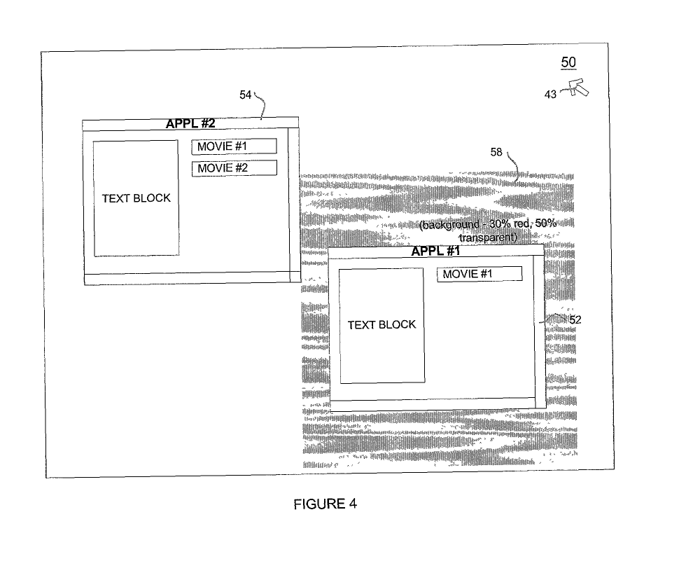

With reference now to FIG. 4, there is depicted a graphical representation of tinting a background window area in accordance with the method, system, and program of the present invention. In the example, a defined window area 58 of display area 50 is adjusted in tint and transparency in order to draw attention to the status of window 52. In particular, the defined window area 58 is adjusted to 50% transparency and 30% red tint to indicate that a failure is occurring in association with window 52.

In particular, where display area 50 is a transparent output interface, such as headset glasses or transparent windshield in a vehicle, it is advantageous to adjust the tint and transparency of the display area in addition to the tint and transparency of windows displayed within the display area. By adjusting the tint of a portion of the display of headset glasses, the viewers attention is drawn to the portion of the display area that is less transparent or tinted.

In the example, only a defined portion of display area 50 is adjusted in transparency and tint. However, in alternate embodiments, the entirety of display area 50 may be adjusted in transparency and tint. In addition, multiple portions may be adjusted in transparency and tint. Further, a display area that is typically opaque may be made more transparent to focus a viewers attention on portions or all of displayable objects within a display area.

In addition, in the example, window 52 is 0% transparent, such that the adjustment in tint of defined window area 58 of display area 50 is not visible through window 52. However, in alternate embodiments, where window 52 is transparent, the tint adjustment of display area 50 is preferably visible through window 52 according to the selected amount transparency.

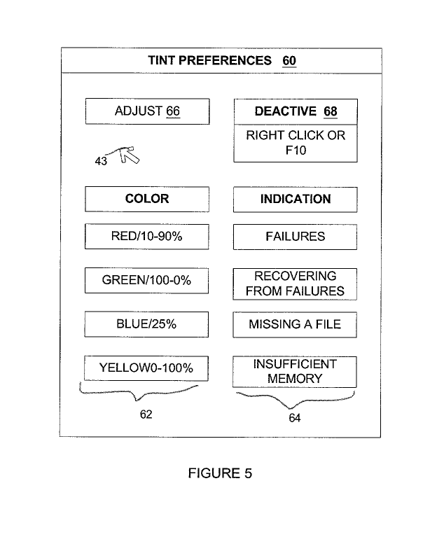

Referring now to FIG. 5, there is depicted a graphical representation of a user interface for selecting tint preferences in accordance with the method, system, and program of the present invention. As illustrated, a window 60 includes a table of colors 62 with associated status indicators 64. In particular, colors 62 represent tints to be added to a window in association with each of status indicators 64. In addition, a range within which the tint is to be added is indicated with each of colors 62. Status indicators 64 provide a description of the computing tasks for which status will be indicated according to tint.

Advantageously, a user may select selectable button 66 with cursor 43 or other input. In response to a selection of selectable button 66, the user is provided with options to add, edit, or delete current tinting preferences.

Further, a user may select a deactivating preference 68 for temporarily removing tinting from a selected window. In the present example, deactivating preference 68 is a right-click or the key command “F10”. In alternate embodiments, alternate types of deactivating inputs may be utilized.

With reference now to FIG. 6, there is depicted a high level logic flowchart of a process and program for graphically adjusting the tints of windows to represent the status of associated computing tasks in accordance with the method, system, and program of the present invention. As illustrated, the process starts at block 70 and thereafter proceeds to block 72.

Block 72 depicts a determination as to whether a status of a preferred computing task is detected in association with a particular window. A preferred computing task is one for which a tint preference has been designated by the user or as a default system setting. If a status of a preferred computing task is not detected, then the process iterates at block 72. If a status of a preferred computing task is detected, then the process passes to block 74.

Block 74 illustrates determining a tint color and hue associated with the computing task. Next, block 76 depicts determining a transparency associated with the status of the computing task. Thereafter, block 78 illustrates graphically adjusting the tint and transparency of the window associated with the computing task to indicate the status of the computing task; and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for adjusting a tint to a window within a user interface to convey a status, said method comprising the steps of:
detecting a status of a non-interactive computing task;
specifying a tint level to represent said status; and
graphically adjusting a tint of at least a selected portion of a displayable object within a display area associated with said non-interactive computing task according to said specified tint level, such that said status of said non-interactive computing task is displayed by said associated displayable object.

2. The method for adjusting a tint to a window according to claim 1, said step of detecting a status further comprising the step of:
detecting said status for at least one from among usage of a processor, memory, a sound card, a graphics card, a storage device, and network bandwidth.

3. The method for adjusting a tint to a window according to claim 1, said method further comprising the step of:
specifying said status according to at least one from among a failure, a recovery, and an insufficiency.

4. The method for adjusting a tint to a window according to claim 1, said method further comprising the steps of:
specifying a transparency level to represent said status of said non-interactive computing task; and
graphically adjusting said transparency according to said transparency level of said at least said selection portion of said displayable object associated with said non-interactive computing task.

5. The method for adjusting a tint to a window according to claim 1, said step of specifying a tint level further comprising the step of:
specifying said tint level according to a user preference for said tint associated with said status of said non-interactive computing task.

6. The method for adjusting a tint to a window according to claim 1, said step of specifying a tint level further comprising the step of:
specifying said tint level, wherein a hue associated with said tint level corresponds to a level of said status.

7. The method for adjusting a tint to a window according to claim 1, said method further comprising the step of:
presenting a user with an interface for selecting tinting preferences, wherein said tinting preferences are utilized for determining said tint level.

8. The method for adjusting a tint to a window according to claim 1, said step of graphically adjusting a tint further comprising the step of:
only graphically adjusting said tint of tint adjustable sections of said displayable object within said selection portion of said displayable object.

9. The method for adjusting a tint to a window according to claim 1, said step of graphically adjusting a tint further comprising the step of:
graphically adjusting said tint of a selection window portion of said display area to highlight said displayable object.

10. The method for adjusting a tint to a window according to claim 1, said step of graphically adjusting a tint further comprising the step of:
graphically adjusting said tint of a said display area, wherein said display area is enabled to adjust in tint.

11. The method for adjusting a tint to a window according to claim 1, said method further comprising the step of:
graphically displaying a plurality of displayable objects according to said tint independent of which of said plurality of displayable objects is actively selected.

12. A system for adjusting a tint to a window within a user interface to convey a status, said system comprising:
a graphical user interface;
means for detecting a status of a non-interactive computing task;
means for specifying a tint level to represent said status; and
means for graphically adjusting a tint of at least a selected portion of a displayable object within a display area of said graphical user interface associated with said non-interactive computing task according to said specified tint level.

13. The system for adjusting a tint to a window according to claim 12, said means for detecting a status further comprising:
means for detecting said status for at least one from among usage of a processor, memory, a sound card, a graphics card, a storage device, and network bandwidth.

14. The system for adjusting a tint to a window according to claim 12, said system further comprising:
means for specifying said status according to at least one from among a failure, a recovery, and an insufficiency.

15. The system for adjusting a tint to a window according to claim 12, said system further comprising:
means for specifying a transparency level to represent said status of said non-interactive computing task; and
means for graphically adjusting said transparency according to said transparency level of said at least said selection portion of said displayable object associated with said non-interactive computing task.

16. The system for adjusting a tint to a window according to claim 12, said means for specifying a tint level further comprising:
means for specifying said tint level according to a user preference for said tint associated with said status of said non-interactive computing task.

17. The system for adjusting a tint to a window according to claim 12, said means for specifying a tint level further comprising:
means for specifying said tint level, wherein a hue associated with said tint level corresponds to a level of said status.

18. The system for adjusting a tint to a window according to claim 12, said system further comprising:
means for presenting a user with an interface for selecting tinting preferences, wherein said tinting preferences are utilized for determining said tint level.

19. The system for adjusting a tint to a window according to claim 12, said means for graphically adjusting a tint further comprising:
means for only graphically adjusting said tint of tint adjustable sections of said displayable object within said selection portion of said displayable object.

20. The system for adjusting a tint to a window according to claim 12, said means for graphically adjusting a tint further comprising:
means for graphically adjusting said tint of a selection window portion of said display area to highlight said displayable object.

21. The system for adjusting a tint to a window according to claim 12, said means for graphically adjusting a tint further comprising:
means for graphically adjusting said tint of a said display area, wherein said display area is enabled to adjust in tint.

22. The system for adjusting a tint to a window according to claim 12, said system further comprising:
means for graphically displaying a plurality of displayable objects according to said tint independent of which of said plurality of displayable objects is actively selected.

23. A program for adjusting a tint to a window within a user interface to convey a status, residing on a computer usable medium having computer readable program code means, said program comprising:
means for enabling detection of a status of a non-interactive computing task;
means for specifying a tint level to represent said status; and
means for controlling graphical adjustment of a tint of at least a selected portion of a displayable object within a display area associated with said non-interactive computing task according to said specified tint level, such that said status of said non-interactive computing task is displayed by said associated displayable object.

24. The program for adjusting a tint to a window according to claim 23, said program further comprising:
means for specifying said status according to at least one from among a failure, a recovery, and an insufficiency.

25. The program for adjusting a tint to a window according to claim 23, said program further comprising:
means for specifying a transparency level to represent said status of said non-interactive computing task; and
means for controlling graphical adjustment of said transparency according to said transparency level of said at least said selection portion of said displayable object associated with said non-interactive computing task.

26. The program for adjusting a tint to a window according to claim 23, said program further comprising:
means for specifying said tint level according to a user preference for said tint associated with said status of said non-interactive computing task.

27. The program for adjusting a tint to a window according to claim 23, said program further comprising:
means for specifying said tint level, wherein a hue associated with said tint level corresponds to a level of said status.

28. The program for adjusting a tint to a window according to claim 23, said program further comprising:
means for only controlling graphical adjustment of said tint of tint adjustable sections of said displayable object within said selection portion of said displayable object.

29. The program for adjusting a tint to a window according to claim 23, said program further comprising:
means for controlling graphical adjustment of said tint of a selection window portion of said display area to highlight said displayable object.

30. The program for adjusting a tint to a window according to claim 23, said program further comprising:
means for controlling graphical adjustment of said tint of a said display area, wherein said display area is enabled to adjust in tint.

31. The program for adjusting a tint to a window according to claim 23, said program further comprising:
means for enabling graphical display a plurality of displayable objects according to said tint independent of which of said plurality of displayable objects is actively selected.
